(19) United States
(12) Patent Application Publication
(10) Pub. No.: US 2022/0003155 A1
(43) Pub. Date: Jan. 6, 2022

(54) METHOD OF INJECTING AMMONIA FUEL INTO A RECIPROCATING ENGINE

(71) Applicant: Commonwealth Scientific and Industrial Research Organisation, Acton, Australian Capital Territory (AU)

(72) Inventor: Louis James WIBBERLEY, Garden Suburb, New South Wales (AU)

(21) Appl. No.: 17/294,182

(22) PCT Filed: Jun. 15, 2020
(86) PCT No.: PCT/AU2020/050601

§ 371 Date: May 14, 2021

(51) Int. Cl. F02B 43/12; F02M 21/02; F02D 41/40; F02M 21/08; F02B 75/02; F02P 23/04

(52) U.S. Cl. CPC F02B 43/12; F02M 21/0203; F02M 21/0275; F02D 41/401; F02D 2041/389; F02B 75/02; F02D 41/402; F02P 23/04; F02M 21/08

(57) ABSTRACT

A method of injection of liquid or gaseous ammonia fuel into a reciprocating engine that includes at least two cylinders, each cylinder including a piston that moves reciprocally within that cylinder, each cylinder having a head location at one end located opposite to a compression end of the piston and defining a combustion chamber therebetween, the cylinder including at least one inlet valve through which combustion gases are fed into the combustion chamber and at least one exhaust valve through which spent combustion gases egress the combustion chamber, the piston moving the cylinder in a cycle between top dead center where the piston is located closest to the head location and bottom dead center where the piston is located furthest from the head location, and including at least one fuel injector located at or in the head location, and wherein the method comprises: injecting the ammonia fuel into the combustion chamber of each cylinder as at least one fuel jet with a timing of: after the at least one exhaust valve of the respective cylinder is substantially closed; and before the respective piston moves to at most 35 degrees, preferably at most 45 degrees, prior to top dead centre.

### PRIORITY CROSS-REFERENCE

The present application claim priority from Australian Provisional Patent Application No. 2019902137 filed 19 Jun. 2019, the content of which should be understood to be incorporated into this specification by this reference.

### TECHNICAL FIELD

The present invention generally relates to a method injecting ammonia fuels into reciprocating engines. The invention is particularly applicable to trunk piston and crosshead engines having 2-stroke and 4-stroke cycles and it will be convenient to hereinafter disclose the invention in relation to that exemplary application. However, it is to be appreciated that the invention is not limited to that application and could be used in a variety of types of reciprocating engines/internal combustion engines.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Presently there is a world-wide interest in fuelling reciprocating engines, particularly compression ignition (diesel) engines, with ammonia-based fuel produced from renewable energy. Ammonia (also termed anhydrous ammonia to distinguish it from ammonia water solutions with relatively low ammonia concentrations) has the potential to provide a cost effective, environmentally friendly, zero carbon fuel.

One issue for using ammonia efficiently in a compression ignition (diesel) engine is how the fuel is introduced or injected into the engine. Several schemes have been used in previously technologies using 4-stroke engines, including:
A. Fumigation by flashing of liquid ammonia into the engine air inlet system either before or after the turbocharger if so equipped—with ignition being initiated via pilot injection of diesel fuel. This is the easiest method of fuelling. However, in most engines the exhaust-inlet valve overlap causing the by-pass of ammonia-containing combustion air to the exhaust giving undesirable high levels of unburnt ammonia in the exhaust gases. This issue is particularly problematic for uniflow 2-stroke engines which require much higher by-pass of combustion air to the exhaust during the cylinder scavenging period. For uniflow 2-stroke engines, this method also increases the potential for dangerous scavenge box fires, and distortion of the scavenge belt from the strong cooling effect of ammonia vaporisation.
B. Fumigation of vaporised ammonia into the engine air inlet system either before or after the turbocharger if so equipped—with ignition being initiated via pilot injection of diesel fuel. This has similar issues to those for fumigation of liquid ammonia, and as gaseous ammonia is used, this method also reduces the potential for cylinder charge cooling in decreasing compression work.
C. Direct injection of liquid ammonia into the cylinder in a similar fashion to conventional diesel fuel engines, with ignition being initiated via pilot injection of diesel fuel. This method is the most difficult to achieve efficient combustion of ammonia due to:
the relatively low rate of vaporisation of ammonia sprays due to the high heat of vaporisation relative to diesel fuel (with cold un-vaporised ammonia to impinging onto hot engine parts, especially the piston, with the potential for thermal stress issues due to the large latent heat of vaporisation of ammonia;
slower combustion due to the heterogeneous mix of ammonia-air in the combustion space;
ammonia is being added late in the compression stroke, resulting in this method decreasing the effect of charge cooling reducing compression work—thereby reducing the overall thermal efficiency; and
higher NOx due to localised higher temperatures.

It would therefore be desirable to mitigate and/or avoid these issues and provide a reciprocating engine with improved ammonia combustion and/or increased thermal efficiency.

### SUMMARY OF THE INVENTION

The present invention provides a method for improving ammonia ignition and combustion in a reciprocating engine.

A first aspect of the present invention provides a method of injection of liquid or gaseous ammonia fuel into a reciprocating engine that includes at least two cylinders, each cylinder including a piston that moves reciprocally within that cylinder, each cylinder having a head location at one end located opposite to a compression end of the piston and defining a combustion chamber therebetween, the cylinder including at least one inlet valve through which combustion gases are fed into the combustion chamber and at least one exhaust valve through which spent combustion gases egress the combustion chamber, the piston moving the cylinder in a cycle between top dead center where the piston is located closest to the head location and bottom dead center where the piston is located furthest from the head location, and including at least one fuel injector located at or in the head location,

and wherein the method comprises:

injecting the ammonia fuel into the combustion chamber of each cylinder as at least one fuel jet with a timing of:

after the at least one exhaust valve of the respective cylinder is substantially closed; and

before the respective piston moves to at most 35 degrees, preferably at most 45 degrees, prior to top dead centre.

It should be appreciated that fuel injection is timed after the at least one exhaust valve is substantially closed to limit unburnt ammonia loss to the exhaust.

Advantageously, the method of the present invention improves ammonia ignition and combustion in an internal combustion engine using liquid or gaseous ammonia fuel. The present invention can also improve ammonia vaporisation after injection into the cylinder, reducing compression work of the engine and where a more homogeneous fuel air mixture also reducing NOx, nitrogen-based particulate emissions for uniflow 2-stroke engines.

Whilst not wishing to be limited to any one theory, the inventor has discovered that combustion of ammonia in engines requires a different method of ammonia injection, especially for uniflow 2-stroke engines. The inventor has found that injection of ammonia into the cylinder substantially before ignition is required to allow increased time for vaporisation and mixing with the combustion air. Ignition has also been found to be enhanced through consideration of the location of the injection points relative to the piston travel, and the timing of injection relative to the movement and position of the piston. It has also been found that early injection of ammonia can be achieved without risk of premature ignition due to a number of factors including the high autoignition temperature of ammonia and the cooling effect of ammonia injection.

The liquid or gaseous ammonia fuel injected in the present invention preferably comprises anhydrous ammonia. This ammonia is typically not an ammonia water solution having a relatively low ammonia concentration. A high/substantive content of ammonia in the ammonia fuel is preferred. The ammonia fuel injected using the method is preferably at least one of a gaseous ammonia fuel, or a liquid ammonia fuel. In some embodiments, the ammonia fuel comprises a blend of liquid ammonia with at least one or water, or another fuel. The ammonia fuel may preferably comprise a blend of liquid ammonia with various amounts of other soluble, miscible, emulsion or slurried fuels. Examples include, but are not restricted to, iron picrate solution, hydrazine, ammonium nitrate, various oxygenated liquids added to enhance ignition, combustion, lubrication or reduce NOx or particulate emissions.

The present invention is applicable for using such ammonia fuels in a reciprocating engine and more preferably an internal combustion engine. The invention can be used in a variety of internal combustion engines, including compression ignition engines or spark, plasma or laser ignition engines. In these embodiments, the head location will preferably comprise a cylinder head.

Aspects of the present invention are also applicable to opposed piston and free piston engines. In these embodiments, each cylinder preferably includes two pistons that move reciprocally within that cylinder in opposite directions, forming a compression end at the head location and combustion chamber therebetween, at least one inlet valve or port (typically located in a cylinder side wall) through which combustion gases are fed into the combustion chamber and at least one exhaust valve or port (typically located in a cylinder side wall) through which spent combustion gases egress the combustion chamber, the pistons moving the cylinder in a cycle between top dead center where the piston is located closest to the opposite piston and bottom dead center where the piston is located furthest from the opposite piston, and including at least one fuel injector located in the cylinder wall.

In opposed piston and free piston engines embodiments, the head of the pistons (in most cases the rings thereon) act to cover and uncover ports in the cylinder walls which together form an inlet and exhaust valve. Thus, each of the inlet valve/port and exhaust valve/port is uncovered by a respective piston during the respective piston stroke. Here, one piston has an inner face that uncovers at least one inlet valve port closest to that piston's outermost travel through which combustion gases are fed into the combustion chamber and the other opposite piston has an inner face that uncovers at least one exhaust valve towards that piston's outermost travel through which spent combustion gases egress the combustion chamber.

It should be appreciated that present invention is applicable to opposed piston engines and free piston engines without a crank. These engines may use a linear generator to take-off power and to drive compression. In some forms, the opposed piston engines may have a scavenge belt at one end and exhaust belt at the other end.

A compression ignition engine is a type of internal combustion engine in which ignition of fuel injected into a combustion chamber of an engine cylinder is caused by the elevated temperature of the air in the cylinder due to the mechanical compression. The expansion of the high-temperature and high-pressure gases produced by combustion applies direct force to drive motion of a piston within a cylinder, which in turn drives motion of a driven section of the engine. Compression ignition engines include engines such as diesel engines. However, it should be appreciated that the compression ignition engine of the present invention is not limited to diesel type engine configurations.

It should be appreciated that the cylinder location defines a top or upper limit or point of the cylinder which the piston moves towards in its reciprocating motion within the cylinder. In many cylinder configurations the head location is defined by the cylinder head. However, in those cylinder configurations that do not include a cylinder head, for example opposed piston and free piston engines, the head location comprises the point in the cylinder marking the maximum top limit of that movement at the cylinder in the compression and exhaust stroke (as described below).

It should also be appreciated that top dead centre of a piston within its respective cylinder is when the piston is at the closest position to the cylinder head/head location within the cylinder during its reciprocating movement and that bottom dead center at the furthest spaced apart position from the cylinder head/head location during its reciprocating movement. In a multi-cylinder engine, pistons may reach top dead centre simultaneously or at different times depending on the engine configuration. In a reciprocating engine, top dead centre of piston number one is the point from which ignition system measurements are made and the firing order is determined. For example, ignition timing is normally specified as degrees of crankshaft rotation before top dead centre (BTDC).

In most reciprocating engines, the piston moves in a particular stroke cycle (a reciprocating movement/reciprocating cycle) within the cylinder in a series of repeated cycle of strokes as follows:

an inlet stroke in which the exhaust valve is closed, the inlet valve is open, and the piston is initially located top dead center proximate but spaced away from the head location and moves away from the head location to draw a fuel/air mixture (or air alone, in the case of a direct injection engine) into the piston;

a compression stroke in which the exhaust valve and the inlet valve are closed, and the piston is initially located bottom dead center and moves toward the head location to compress the air/fuel mixture (or air alone until fuel is injected into the combustion chamber, in the case of a direct injection engine) in the combustion chamber. Towards the end of this phase, the fuel/air mixture is ignited—for example, by a spark plug or other ignition means for petrol engines, or by self-ignition for compression ignition engines such as diesel engines;

a combustion stroke in which the exhaust valve and inlet valve are closed, and the piston is initially located top dead center and expansion of the ignited fuel mixture is forced away from the head location by in the combustion chamber between the head location and piston head (compression end of the piston); and

an exhaust stroke, where the exhaust valve is open and the inlet valve is closed, and the piston is initially located bottom dead center and moves towards the head location to expel the spent combustion gases through the exhaust valve. This stroke cycle is repeated.

It should be appreciated that fuel is injected into the combustion chamber of direct injection engines during the compression stroke to enable the combustion stroke to occur. It should also be appreciated that the combustion gases comprise air, or air with O₂ and/or with other combustibles.

In the context of this repeated cycle of strokes, the ammonia fuel is preferably injected into the combustion chamber of each cylinder during compression stroke of the engine cycle. In this context, the ammonia fuel is combusted in that combustion stroke by compression (compression ignition engines) or by a spark, plasma, laser combustion initiator.

Whilst not discussed in the context of the piston movement above, it should be understood the cylinder and piston of the present invention can operate and incorporates the features of a conventional reciprocating engine, and more particularly an internal combustion engine. For example, in many internal combustion engines the base of each piston is preferably connected to a connecting rod, which is in turn connected to a crankshaft. The reciprocating movement of each piston drives rotation of that crankshaft. Thus, the connecting rod converts the rotary motion of the crankshaft into the back-and-forth motion of the piston in its cylinder. The cylinder has the cylinder head at one end and is open at the other end to allow the connecting rod to do its work. The piston is effectively sealed to the respective cylinder by two or more piston rings. However, again it should be appreciated that other configurations are possible. For example, instead of a crank an engine may use a linear generator to take-off power and to drive compression.

In the context of the above, it should also be appreciated that movement of the piston in degrees referred throughout this specification is in crank degrees, i.e. the relative rotation of the crank corresponding to the driven reciprocal movement of the piston. Each full cycle of reciprocating movement of the piston between top dead center corresponds to 360 degrees movement of the crank shaft.

The features of this piston arrangement and associated engine configuration are well known in the art. It is to be understood that operation and configuration of such an internal combustion engine would be well understood by a person skilled in the art, and the features of the method of the method for injection of liquid or gaseous ammonia fuel into a reciprocating engine according to the present invention could be readily adopted by the person skilled in the art in a conventional reciprocating engine following the teaching of the present specification.

This first aspect of the present invention typically relates to direct injection engines where the fuel injector is located at or in the head location in a cylinder head of that cylinder. A variety of injector configurations are possible. For example, the fuel injector may comprise at least one of: a single fuel injector located in the center of the cylinder head; or at least two fuel injectors spaced apart across the diameter of the cylinder head. In some embodiments, the fuel injector comprises at least one semi-axial nozzle fuel injector located near the centre of the cylinder with near fuel jets directed downwards. In other embodiments, the fuel injector comprises at least one semi-axial discharge nozzle liquid ammonia injector(s) located near the cylinder wall with near semi-axial fuel jets directed downwards towards the piston.

As set out previously, ignition using ammonia fuel has also been found to be enhanced through consideration of the location of the injection points relative to the piston travel, and the timing of injection relative to the movement and position of the piston.

In some embodiments, the ammonia fuel is injected into the combustion chamber of each cylinder with a timing of:

after the at least one exhaust valve is substantially closed; and

before the piston moves to 35 degrees prior to top dead centre.

In other embodiments, the ammonia fuel is injected into the combustion chamber of each cylinder with a timing of:

after the at least one exhaust valve is substantially closed; and

before the piston moves to 45 degrees prior to top dead centre.

Ignition using ammonia fuel has also been found to be enhanced when the timing of injecting ammonia fuel into the combustion chamber of each cylinder also occurs after the at least one inlet valve is closed. This mitigates leakage of the ammonia fuel and combustion gases into the fuel inlet/intake valve. Thus, in particular embodiments, the ammonia fuel is injected into the combustion chamber of each cylinder with a timing of:

after the at least one exhaust valve is substantially closed;

after the at least one inlet valve is closed; and

before the piston moves to 35 degrees before top dead centre.

In a number of embodiments, the angle in which the fuel jet(s) enter the cylinder has also been found to be important, as set out below. It should be appreciated that these parameters may differ for different piston/cylinder configurations for example as set out in the two aspects of the invention.

In embodiments, the ammonia fuel is injected into the combustion chamber of each cylinder such that the fuel jets enter the cylinder having a jet centreline that is at an angle of between −90° and −35° relative to a base line which is perpendicular to the centreline of the respective cylinder. In some embodiments, the ammonia fuel is injected into the combustion chamber of each cylinder such that the fuel jets enter the cylinder having a jet centreline that is at an angle of between −90° and −50°, preferably between −90° and −65° relative to a base line which is perpendicular to the centreline of the respective cylinder.

In other embodiments, the ammonia fuel is injected into the combustion chamber of each cylinder such that the fuel jets enter the cylinder having a jet centreline that is at an angle of between −90° and −30° relative to a base line which is perpendicular to the centreline of the respective cylinder.

In particular embodiments, the ammonia fuel is injected into the combustion chamber of each cylinder such that the fuel jets enter the cylinder having a jet centreline that is at an angle of between −90° and −65° relative to a base line which is perpendicular to the centreline of the respective cylinder, and wherein injection is timed to occur after the at least one exhaust valve closes and before the piston moves to 35 degrees of top dead centre.

In other embodiments, the ammonia fuel is injected into the combustion chamber of each cylinder such that the fuel jets enter the cylinder having a jet centreline that is at an angle of between −90° and −50° relative to a base line which is perpendicular to the centreline of the respective cylinder, and wherein injection is timed to occur after the at least one exhaust valve closes and before the piston moves to 45 degrees of top dead centre.

The method of this first aspect of the present invention can be used in a variety of types of reciprocating engines, including at least one of: a compression ignition engine; or a spark, plasma or laser ignition engine. That reciprocating engine may be a two-stroke engine, or a four-stroke engine. Similarly, that reciprocating engine may be a crosshead or trunk uniflow engine.

The method of the present invention can be advantageously used for low, medium and high-speed engines, both trunk piston and crosshead engines, 2- and 4-stroke cycles, and spark, plasma or laser ignited engines. The present invention is particularly applicable to conventional trunk piston 2-stroke engines, and for lower speed cross head engines such as are used for deep water marine. Particular embodiments of the first aspect of the present invention are as follows:

For top injection (injector located in the cylinder head) trunk piston uniflow 2-stroke engines, the method of the first aspect of the present invention comprises injecting the ammonia fuel into the combustion chamber of each cylinder as at least one fuel jet as one or more fuel jets at an angle A of −90° and −35° with the ammonia fuel injection being timed to occur after the exhaust valves close and before 45 crank degrees of top dead centre.

For top injection (injector located in the cylinder head) crosshead uniflow 2-stroke engines, the method of the first aspect of the present invention comprises injecting the ammonia fuel into the combustion chamber of each cylinder as one or more fuel jets form an angle A of between −90° and −30° and with the ammonia fuel injection being timed to occur after the exhaust valve(s) close and before 35 crank degrees of top dead centre.

A second aspect of the present invention provides a method of injection of liquid or gaseous ammonia fuel into a reciprocating engine that includes at least two cylinders, each cylinder including a piston that moves reciprocally within that cylinder, each cylinder having a head location at one end located opposite to a compression end of the piston and defining a combustion chamber therebetween, the cylinder including at least one inlet valve through which combustion gases are fed into the combustion chamber and at least one exhaust valve through which spent combustion gases egress the combustion chamber, the piston moving the cylinder in a cycle between top dead center where the piston is located closest to the head location and bottom dead center where the piston is located furthest from the head location, and including at least one fuel injector located in the wall of the cylinder spaced away from the head location, the injector being positioned to inject fuel into the combustion chamber, and

wherein the method comprises:

injecting the ammonia fuel into the combustion chamber of each cylinder as at least one fuel jet such that the fuel jets enter the combustion chamber having a jet centreline that is at an angle of between −80° and 80° relative to a base line which is perpendicular to the centreline of the respective cylinder, and

wherein injection is timed to occur:

after the at least one exhaust valve of the respective cylinder is substantially closed; and

before the at least one fuel injector is covered by the respective piston when moving from bottom dead center to top dead center in each respective cylinder.

This second aspect of the present invention also provides a method of the present invention improves ammonia ignition and combustion in an internal combustion engine using liquid or gaseous ammonia fuel. This second aspect of the present invention relates to direct injection engines where the fuel injector or injectors are located in the walls of the cylinder. However, it should be appreciated that the previously discussed advantages, piston stroke cycle, engine components and the like described in relation to the first aspect of the present invention equally apply to this second aspect of the present invention.

As noted for the first aspect, the cylinder location defines a top or upper limit or point of the cylinder which the piston moves towards in its reciprocating motion within the cylinder. In many cylinder configurations the head location is defined by the cylinder head. However, in those cylinder configurations that do not include a cylinder head, for example opposed piston and free piston engines, the head location comprises the point in the cylinder marking the maximum top limit of that movement at the cylinder in the compression and exhaust stroke (as described above). It should also be appreciated that the engine types previously discussed are also applicable for this second aspect of the present invention.

The ammonia fuel is preferably at least one of a gaseous ammonia fuel, or a liquid ammonia fuel. In some embodiments, the ammonia fuel comprises a blend of liquid ammonia with at least one or water, or another fuel. The ammonia fuel may preferably comprise a blend of liquid ammonia with various amounts of other soluble, miscible, emulsion or slurried fuels. Examples include, but are not restricted to, iron picrate solution, hydrazine, ammonium nitrate, various oxygenated liquids added to enhance ignition, combustion, lubrication or reduce NOx or particulate emissions.

Again, fuel injection is timed after the at least one exhaust valve is substantially closed to limit unburnt ammonia loss to the exhaust. Furthermore, in the context of the previously discussed repeated cycle of strokes, the ammonia fuel is preferably injected into the combustion chamber of each cylinder during compression stroke of the engine cycle. In this context, the ammonia fuel is combusted in that combustion stroke by compression (compression ignition engines) or by a spark, plasma, laser combustion initiator.

As indicated above, this second aspect of the present invention relates to direct injection engines where the fuel injector or injectors are located in the walls of the cylinder. The injectors are preferably located in the cylinder sidewall in the lower half of the cylinder relative to movement of the piston between top deal center and bottom dead center (i.e. piston-top travel). The fuel jet is therefore injected into the bottom half of the cylinder. In some embodiments, the at least one fuel injector is located in the wall of the cylinder spaced away from the cylinder head to define an upper section of the cylinder between the at least one fuel injector and cylinder head and a lower section located between the at least one fuel injector and the piston when bottom dead center. In these embodiments, the fuel jet can be injected into the upper section or bottom section of the cylinder.

A variety of injector configurations are possible. For example, the fuel injector may comprise at least one of: a single fuel injector; or at least two fuel injectors circumferentially spaced apart around the circumference of the cylinder wall. In some embodiments, the fuel injector comprises at least one semi-axial nozzle fuel injector located near the centre of the combustion chamber when the piston is bottom dead center with near fuel jets directed downwards. In other embodiments, the fuel injector comprises at least one liquid ammonia injectors placed low in the cylinder wall. The low position in the cylinder wall typically comprises being closer to the compression end of the piston than the cylinder head when the piston is bottom dead center.

Ignition using ammonia fuel in this second aspect of the present invention has also been found to be enhanced when the timing of injecting ammonia fuel into the combustion chamber of each cylinder also occurs after the at least one inlet valve is closed. This mitigates leakage of the ammonia fuel and combustion gases into the fuel inlet/intake valve.

As with the first embodiment, the angle in which the fuel jet(s) enter the cylinder has also been found to be important, as set out below. It should be appreciated that these parameters may differ for different piston/cylinder configurations for example as set out in the two aspects of the invention.

In embodiments, the at least one fuel jet is injected into combustion chamber having a jet centreline that is at an angle of −80° and 40° relative to a base line which is perpendicular to the centreline of the respective cylinder.

In some embodiments, the at least one fuel jet is injected into combustion chamber having a jet centreline that is at an angle of −80° and 0° relative to a base line which is perpendicular to the centreline of the respective cylinder.

In other embodiments, the at least one fuel jet is injected into combustion chamber having a jet centreline that is at an angle of −80° and −40° relative to a base line which is perpendicular to the centreline of the respective cylinder.

The method of this second aspect of the present invention can be used in a variety of types of reciprocating engines, including at least one of: a compression ignition engine; or a spark, plasma or laser ignition engine. That reciprocating engine may be a two-stroke engine, or a four-stroke engine. Similarly, that reciprocating engine may be a crosshead or trunk uniflow engine.

Again, the method of the present invention can be advantageously used for low, medium and high-speed engines, both trunk piston and crosshead engines, 2- and 4-stroke cycles, and spark, plasma or laser ignited engines. The present invention is particularly applicable to conventional trunk piston 2-stroke engines, and for lower speed cross head engines such as are used for deep water marine. Particular embodiments of the second aspect of the present invention are as follows:

For side injection (fuel injectors located in the walls of the cylinder) trunk piston uniflow 2-stroke engines, the method of the second aspect of the present invention comprises injecting the ammonia fuel into the combustion chamber of each cylinder as one or more fuel jets into the combustion chamber with an angle A of −80° to 80°, with the ammonia fuel injection being timed to occur after the exhaust valves close and before the piston covers the injection port(s). The injectors are preferably in the lower half of the cylinder relative to travel of the compression end of the piston (piston-top travel) between top dead center and bottom dead center.

For side injection crosshead uniflow 2-stroke engines, the method of the second aspect of the present invention comprises injecting the ammonia fuel into the combustion chamber of each cylinder as one or more fuel jets into the combustion chamber, to form an angle A of −80° to 80°, with the ammonia fuel injection being timed to occur after the exhaust valve(s) close and before the piston covers the injection port(s). The injectors are preferably in the lower half of the cylinder relative to travel of the compression end of the piston between top dead center and bottom dead center.

In embodiments of both the first and second aspects of the present invention, the injectors could serve both to inject the liquid ammonia and then inject a pilot fuel such as diesel. Preferably, the injectors would have separate nozzles for the ammonia and pilot fuel. In these embodiments, the method of the present invention would further comprise: injecting a pilot fuel, preferably diesel, into the combustion chamber subsequent to injection of the ammonia fuel into the combustion chamber of each cylinder. The ammonia fuel would be injected according to the present invention and the pilot fuel is preferably injected just before the required onset of combustion, preferably immediately prior to the required onset of combustion of the fuel in the combustion chamber. In this embodiment, the amount of pilot injection could also advantageously be used to start and warm the engine before using liquid ammonia and/or be used for low load operation although in normal operation only 2 to 5% of the fuel energy would be necessary for ignition.

### BRIEF DESCRIPTION OF THE DRAWINGS

The present invention will now be described with reference to the figures of the accompanying drawings, which illustrate particular preferred embodiments of the present invention, wherein:

FIG. 1 illustrates the methodology used in the present specification for determining jet angles of fuel injected into a cylinder of an engine through an injector.

FIG. 2 illustrates a system used for specifying fuel jet angles relative to the cylinder centre line of a cylinder of an engine.

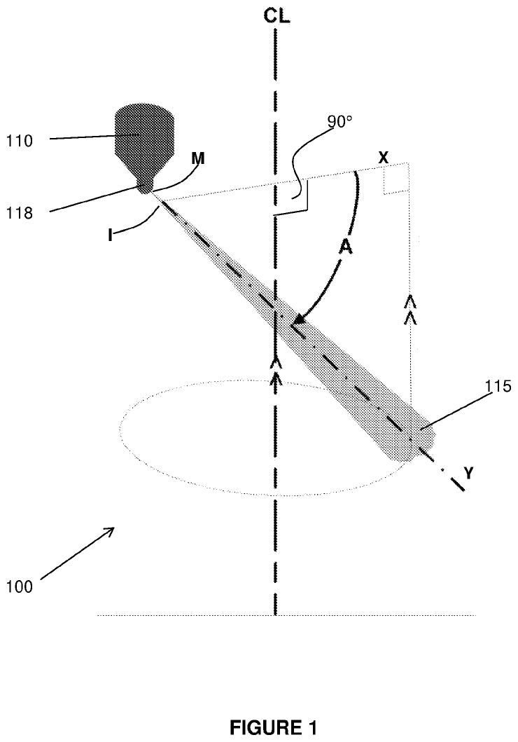

FIG. 1 is a schematic cross-sectional view of one cylinder of a conventional (prior art) trunk uniflow 2-stroke engine showing a radial nozzle fuel injector located near the centre of the cylinder with fuel jets directed outwards.

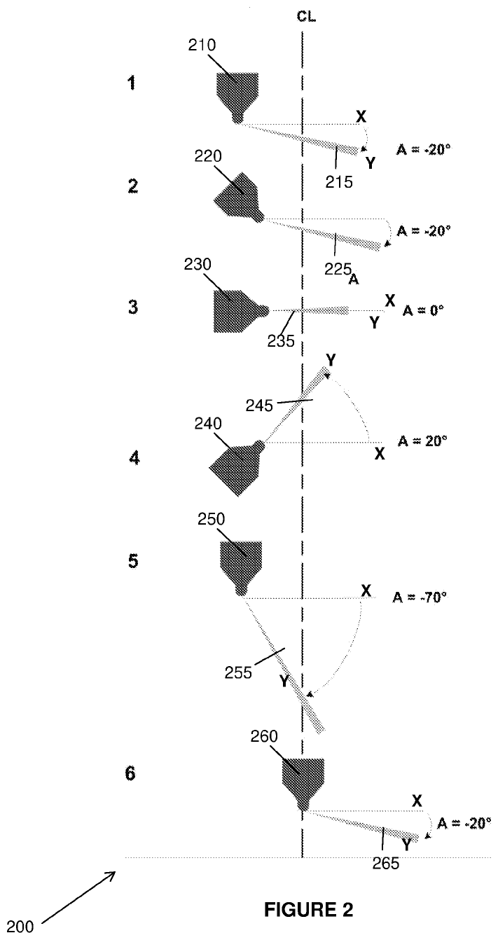

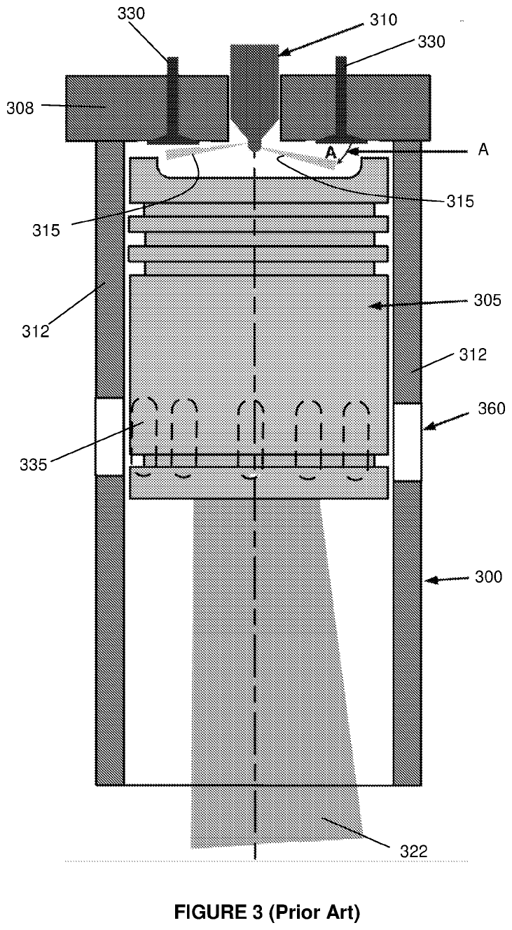

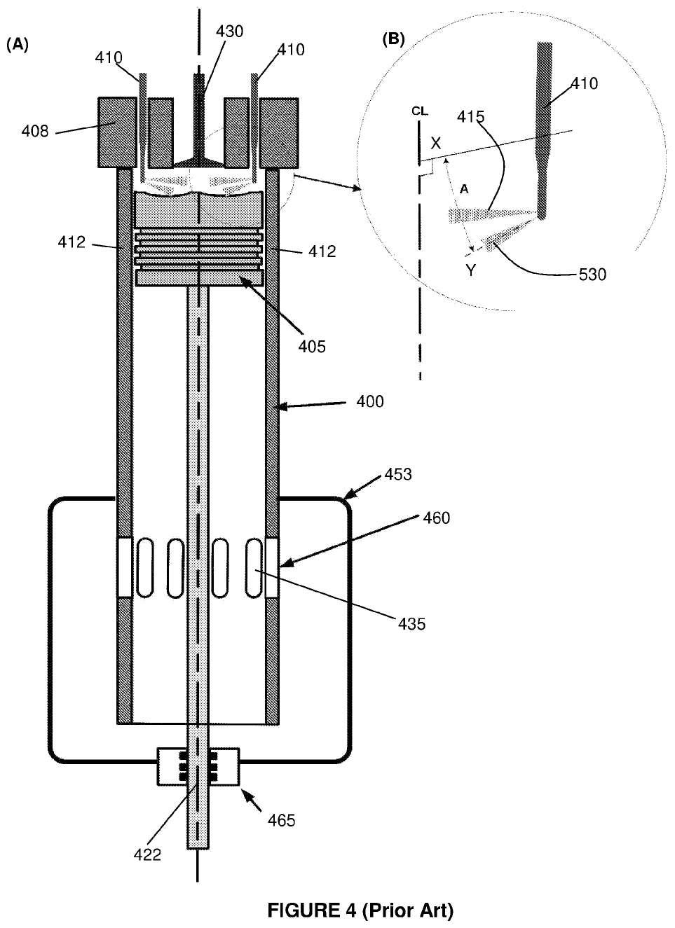

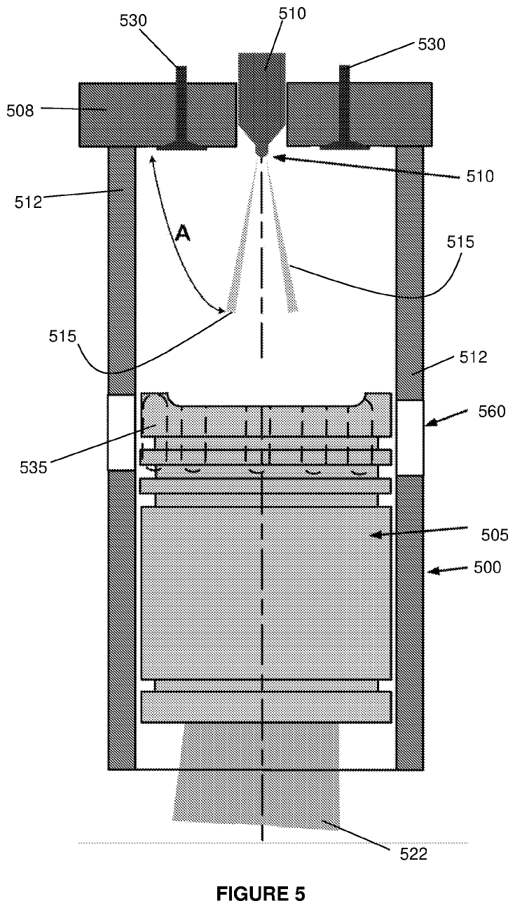

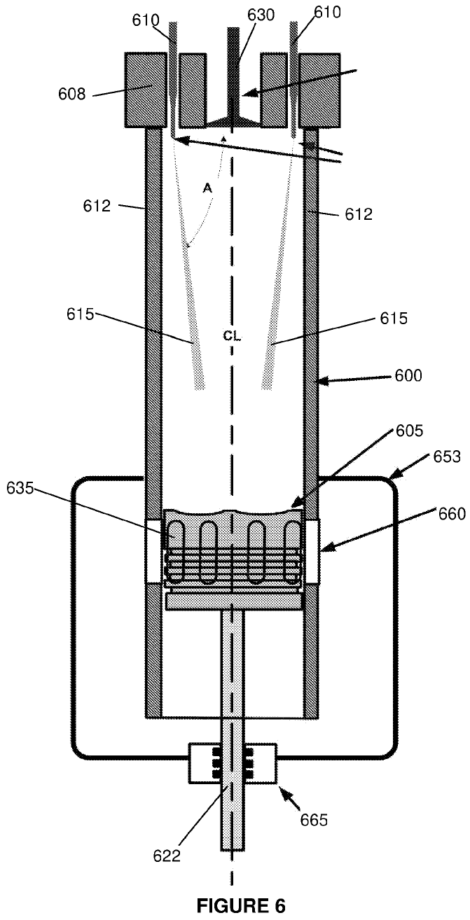

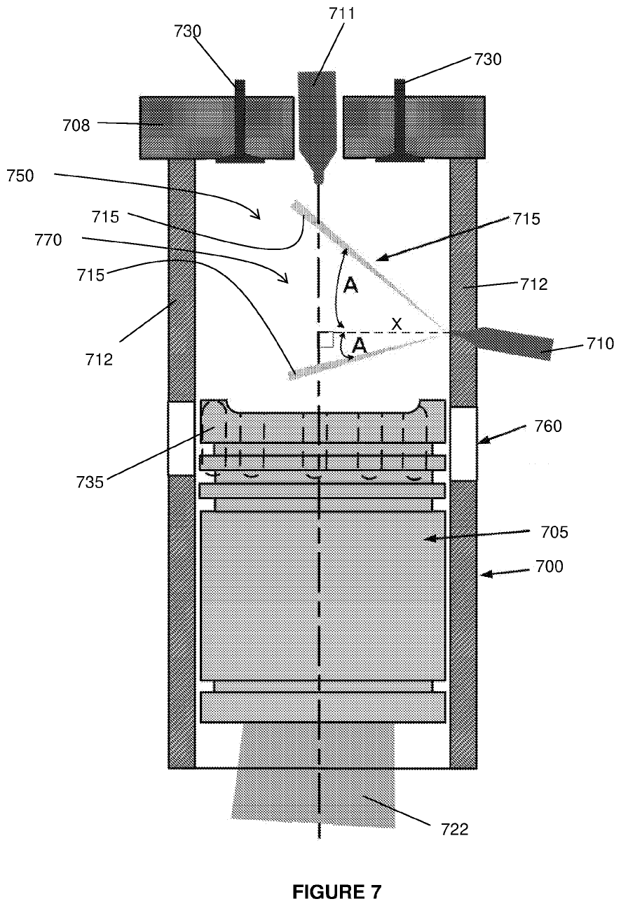

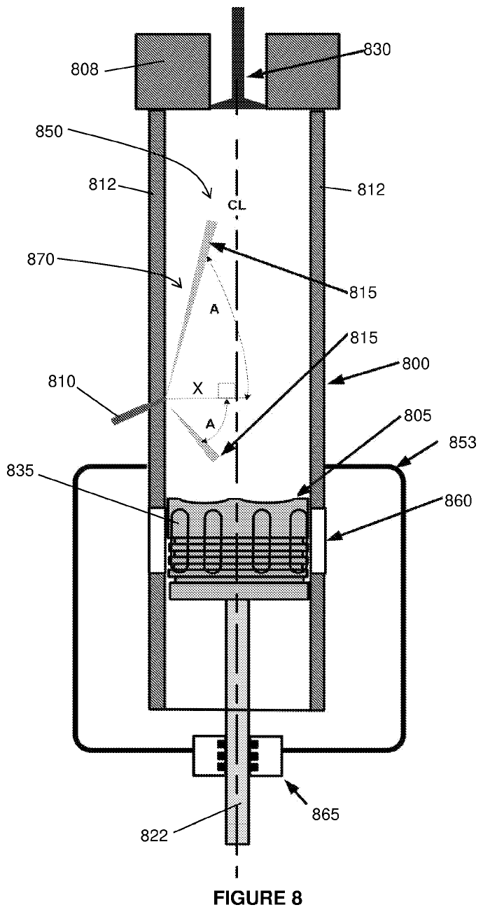

FIG. 2 is (A) a schematic cross-sectional view of one cylinder of a conventional (prior art) crosshead uniflow 2-stroke engine showing a side-discharge fuel injector of the cylinder located near the cylinder wall with fuel jets directed radially inwards; and (B) a close-up of the fuel jet and fuel jet angle A measured relative to the injector and baseline X shown in (A).

FIG. 3 is a schematic cross-sectional view of one cylinder of a trunk uniflow 2-stroke engine with an injector configuration according to one embodiment of the present invention showing a semi-axial nozzle fuel injector located near the centre of the cylinder with near fuel jets directed downwards. Pilot injectors/ignition devices are not shown for clarity.

FIG. 4 is a schematic cross-sectional view of one cylinder of a crosshead uniflow 2-stroke engine of one cylinder with an injector configuration according to an embodiment of the present invention having a semi-axial discharge nozzle liquid ammonia injector(s) located near the cylinder wall with near semi-axial fuel jets directed downwards towards the piston. Pilot injectors/ignition devices are not shown for clarity.

FIG. 5 is a schematic cross-sectional view of one cylinder of a trunk uniflow 2-stroke engine with an injector configuration according to an embodiment of the present invention showing a semi-axial nozzle fuel injector located near the centre of the cylinder with near fuel jets directed downwards.

FIG. 6 is a schematic cross-sectional view of one cylinder a crosshead uniflow 2-stroke engine with an injector configuration according to an embodiment of the present invention comprising liquid ammonia injectors placed low in the cylinder wall with various jet alignment options. Pilot injectors/ignition devices are not shown for clarity.

### DETAILED DESCRIPTION

The method of the present invention provides a method injecting a gaseous or liquid ammonia fuel that improves ammonia ignition and combustion in an internal combustion engine using that liquid or gaseous ammonia fuel. The present invention can also improve ammonia vaporisation after injection into the cylinder, reducing compression work of the engine and also reducing NOx, nitrogen-based particulate emissions for uniflow 2-stroke engines.

### Jet Fuel Injection Angles

FIGS. 1 and 2 illustrate the system and methodology used in the present specification to measure and specify the angle A of a fuel jet injected into the combustion chamber of a cylinder engine (not illustrated for ease of reference of the schematic) from a fuel jet injector.

Firstly, as shown in FIG. 1 a fuel jet 115 injected from an injector 110 will undergo a degree of spread as the fuel jet 115 emanates out from the nozzle 118 of the fuel injector 110. All angles A referenced with respect to a fuel jet hereinafter are with reference to the centreline Y of the jet spray of the respective fuel jet 115 starting from the injection point M at the nozzle 118.

Secondly, all angles of the fuel jet 115 sprayed within the cylinder are measured relative to a baseline X. Baseline X is a line which is perpendicular to the centreline CL of the respective cylinder. For ease of reference, the baseline X can be positioned to intersect through point of intersection I with the centreline Y of the fuel jet 115 to show angle A therebetween. However, it should be appreciated that this baseline can be used as a reference for angle A at any suitable position relative to the centreline Y of the fuel jet 115.

Using the centreline CL of the respective cylinder, baseline X and fuel jet centreline Y, the angle A references the angle the fuel jet 115 is sprayed out from the nozzle 118 of injector 110 into the combustion chamber of the cylinder.

FIG. 2 illustrates six examples of this measurement using this system. B All angles A are measured between the fuel jet centreline Y of each fuel jet and baseline Y which is perpendicular to the centreline CL of the respective cylinder. As measured in FIG. 1, the illustrative angles are set out in Table 1:

TABLE 1
Measured fuel-jet examples

| | | Angle A |
|---|---|---|
| Injector No. | Fuel Jet | (degrees) |
| 210 | 215 | −20 |
| 220 | 225 | −20 |
| 230 | 235 | 0 |
| 240 | 245 | 20 |
| 250 | 255 | −70 |
| 2160 | 265 | −20 |

Using this nomenclature, the angle A of a variety of fuel jets can be described.

It should be noted that while the fuel jet angles A will be described in terms of their inclination in a single plane, compound jet angles could also advantageously be used with ammonia fuel jets directed either with or against the swirl flow pattern in the combustion air as usually induced by the scavenge belt ports to improve cylinder emptying of exhaust gases. The fuel jet angle(s) A are measured as true angles with respect to the cylinder centre line (CL) and a plane normal to the cylinder centre line (CL).

### Conventional Fuel Injection

The present invention more effectively uses ammonia as a combustion fuel in an internal combustion engine by using different method of ammonia injection, particularly for uniflow 2-stroke engines. As a point of comparison, FIGS. 3 and 4 provide a schematic showing the method of fuel injection of fuel in a conventional (prior art) trunk uniflow 2-stroke engine (FIG. 3) and a conventional (prior art) crosshead uniflow 2-stroke engine (FIG. 4).

Firstly, referring to FIG. 3, which illustrates a cross-sectional view of one cylinder 300 and piston 305 combination for a conventionally fuelled trunk piston uniflow 2-stroke engine. The cylinder 300 includes a cylinder head 308 having a radial nozzle fuel injector 310 located near the centre of the cylinder 300 and cylinder head 308 which directs fuel jets 315 outwardly therefrom towards the cylinder walls 312. The cylinder head 308 includes exhaust outlet valves 330. As illustrated, the piston 305 includes a connecting rod 322 which is connected at the other end to a crankshaft (not shown). The cylinder 300 also includes a scavenger belt 360 which include inlet ports 335 that are uncovered by the piston 305 towards the bottom of the piston stroke (when the piston 305 is close to bottom dead center). In this schematic, the fuel is injected through injector 310 such that the centreline Y of fuel jets 315 form an angle A of −30° and +5° relative to baseline X. The injectors 310 would typically include 4 to 16 orifices in the nozzle. The fuel injection events are time to start between 35° and 10° of crankshaft rotation before the piston reaches the top of the compression stroke i.e. before top dead centre (BTDC).

FIG. 4 illustrates a cross-sectional view of one cylinder 400 and piston 405 combination of a conventionally fuelled crosshead uniflow 2-stroke engine. The illustrated cylinder 400 includes a cylinder head 408 having at least two side-discharge fuel injectors 410 located near the cylinder wall 412 with fuel jets 415 directed inwards (i.e. away from the cylinder walls 412). The cylinder head 408 includes a central exhaust outlet valve 430. As illustrated, the piston 405 includes a piston rod 422 which is interconnected at the other end to a crosshead then connecting rod to a crankshaft (not shown). The cylinder 400 also includes a surrounding scavenge box 455 which encloses a scavenge belt 460 in the cylinder wall 412 which include inlet ports 435 that are uncovered by the piston 405 towards the bottom of the piston stroke (when the piston 405 is close to bottom dead center). Piston rod 422 intersects and is inserted through scavenger box 453 via stuffing box 465. As shown, the fuel is injected through injectors 410 as fuel jets 415 which form an angle A of between −25° and +5° relative to baseline X. The injectors 410 would typically include 4 to 8 orifices in the nozzle. The fuel injection events are time to start between 15° of crankshaft rotation BTDC through to several degrees after top dead centre (ATDC) depending on engine size and fuel ignition properties.

### Fuel Injection of the Present Invention

The present invention comprises different injection arrangements based on newly discovered requirements for fuelling engines with either liquid or gaseous ammonia fuels. The inventor has found that more effective combustion can be achieved when ammonia fuel is injected much earlier in the compression cycle of each cylinder of an engine than for that normally taught for compression ignition engines, for example the two prior art engine configuration discussed above in relation to FIGS. 3 and 4. Fuel injection for the injection regime of the present invention occurs just after the exhaust valve(s)/ports are closed and deeper into the cylinder volume (i.e. steeper fuel jet injection angle) to ensure sufficient time for vaporisation and mixing, reduce compression work and to allow more complete combustion.

FIG. 5 shows a cross-sectional view of one cylinder 500 and piston 505 combination for a trunk piston uniflow 2-stroke engine using the ammonia fuel injection method of the present invention. The cylinder and piston configuration are the same as described in relation to FIG. 3. Accordingly, like features have been provided the same reference numeral plus 200. In this schematic, the ammonia fuel is injected through injector 510 such that the centreline Y of fuel jets 515 enter the cylinder at an angle A of −90° and −35°. The injector 510 would typically include 1 to 4 orifices in the nozzle. Ammonia injection is timed to occur after the exhaust valve(s) 530 close and before 45 crank degrees of top dead centre. The exhaust valves 530 are closed during ammonia injection so to limit/control ammonia slip to the exhaust.

FIG. 6 which illustrates a cross-sectional view of one cylinder 600 and piston 605 combination of a fuelled crosshead uniflow 2-stroke engine 400. using the ammonia fuel injection method of the present invention. The cylinder and piston configuration are the same as described in relation to FIG. 4. Accordingly, like features have been provided the same reference numeral plus 200. In this schematic, the ammonia fuel is injected through injector 610 such that the centreline Y of fuel jets 615 enter the cylinder at angle A of between −90° and −30°. The injector 610 would typically include 1 to 4 orifices in the nozzle. Ammonia injection is timed to occur after the exhaust valve(s) 630 close and before 35 crank degrees of top dead centre. The exhaust valves 630 are closed so to limit/control ammonia slip to the exhaust.

An alternative form of invention applied to trunk piston uniflow 2-stroke engines where the ammonia fuel is injected using the fuel injection method of the present invention is shown in FIG. 5. A cross-sectional view of one cylinder 700 and piston 705 is illustrated. The cylinder and piston configuration are the same as described in relation to FIG. 3. Accordingly, like features have been provided the same reference numeral plus 400. This embodiment is a side injector configuration, having semi-axial nozzle ammonia fuel injector 710 located in the cylinder wall 712 with near fuel jets 715 directed towards the centre of the cylinder. This injector 710 would typically include 1 to 4 orifices in the nozzle. For large cylinders several such injectors may be used to improve mixing and reduce the chilling effect on the cylinder wall—a suitable arrangement is using one injector for each 300-400 mm increment of cylinder circumference. In this schematic, the fuel injector 710 is located in the lower half 770 of the cylinder 700 relative to piston travel between top dead center and bottom dead center (piston-top travel) and the one or more fuel jets 712 are injected into combustion chamber 750 of the cylinder 700 in an angle A of −80° to 80° relative to baseline X. As shown in this schematic, fuel jets 715 may travel upwardly or downwardly relative to the injector 710. Ammonia injection is timed to occur after the exhaust valve(s) 730 close and before the piston covers the injection port(s). The exhaust valve(s) 730 are closed so to limit/control ammonia slip to the exhaust. This arrangement is advantageous for smaller bore trunk engines as it frees the cylinder head/cover for the location of the pilot injector(s) (for example 711 described in more detail below) or other ignition devices. In all cases injection timing would be after the exhaust valve(s) are closed and before the piston covers the injection port(s) 735 on the up-stroke or compression stroke. The location of the fuel jet 715 and the jet angle A used can be further optimised to provide the required mixing of the air-fuel in the cylinder 700.

An alternative form of invention as applied to crosshead uniflow 2-stroke engines the fuel is injected using the ammonia fuel injection method of the present invention is shown in FIG. 6. A cross-sectional view of one cylinder 800 and piston 805 is illustrated. The cylinder and piston configuration are the same as described in relation to FIG. 4. Accordingly, like features have been provided the same reference numeral plus 400. This embodiment is a side injector configuration, having ammonia injectors 810 placed low in the cylinder wall 812 with various jet alignment options. The injector 810 typically has 1 to 4 orifices in the nozzle. For large cylinders several such injectors may be used to improve mixing and reduce the chilling effect on the cylinder wall—a suitable arrangement is using one injector for each 300-400 mm increment of cylinder circumference. In this schematic, the fuel injector 810 is located in the lower half 870 of the cylinder 800 relative to piston travel between top dead center and bottom dead center (piston-top travel) and one or more fuel jets 812 are injected into the combustion chamber 850 at an angle A of −80° to 80°. As shown in this schematic, fuel jets 815 may travel upwardly or downwardly relative to the injector 810. Ammonia injection is timed to occur after the exhaust valve(s) 830 close and before the piston covers the injection port(s). The exhaust valves 830 are closed so to limit/control ammonia slip to the exhaust. This arrangement is advantageous for smaller bore engines as it frees the cylinder head/cover for the location of the pilot injector(s) or other ignition devices.

While the invention as shown in FIG. 3 to FIG. 6 relates mostly to injection of liquid ammonia, these arrangements could also use gaseous ammonia injection, with the vaporisation produced external to the cylinder and advantageously using waste heat such as engine coolant. Advantages of the gaseous version of the invention include efficient utilisation of low-grade waste heat such as from hot engine coolant, better fuel-air mixing, higher compression temperature which is of particular advantage to assist combustion for faster engines. In addition, subject to avoiding excessive ammonia slip to the exhaust the injection of gaseous ammonia before the piston closing the scavenge ports would displace some combustion air in the cylinder effectively reducing compression loss for a given expansion work and give a higher fuel:air ratio for a given boost/scavenge air pressure. A further advantage of this embodiment of the invention is that relatively ammonia vaporiser temperatures of 60 to 100° C. would produce vapour at sufficiently high pressure to allow direct cylinder injection without the use of a gas compressor.

Whilst the invention has been described with reference to liquid ammonia fuel, other blends of liquid ammonia with various amounts of water can be used.

Whilst the invention has been described with reference to liquid ammonia fuel, other blends of liquid ammonia with various amounts of other soluble, miscible, emulsion or slurried fuels can be used, these include, but are not restricted to, iron picrate solution, hydrazine, ammonium nitrate, various oxygenated liquids added to enhance ignition, combustion, lubrication or reduce NOx or particulate emissions.

Whilst the invention has been described with reference to fuel injectors for injection of ammonia fuel only, in further embodiments the injectors could serve both to inject the liquid ammonia and then inject a pilot fuel such as diesel. One embodiment that could include a pilot injector 711 is shown in FIG. 7, where the pilot injector 711 is included in the cylinder head 708. It is envisaged that such injectors would have separate nozzles for the ammonia and pilot fuel wherein the liquid ammonia is injected according to the present invention and the pilot fuel is injected just before the required onset of combustion as in conventional diesel engines. In this embodiment, the amount of pilot injection could also advantageously be used to start and warm the engine before using liquid ammonia and/or be used for low load operation although in normal operation only 2 to 5% of the fuel energy would be necessary for ignition.

Whilst the invention has been described concerning compression ignition and pilot injection being used for ignition control in further embodiments of the present invention other methods of ignition could advantageously be used including spark, plasma and laser ignition.

Whilst the invention has been described with reference to 2-stroke engines, the invention can also be applied to the compression stroke of 4-stroke engines.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1.-39. (canceled)

40. A method of injection of liquid or gaseous ammonia fuel into a reciprocating engine that includes at least two cylinders, each cylinder including a piston that moves reciprocally within that cylinder, each cylinder having a head location at one end located opposite to a compression end of the piston and defining a combustion chamber therebetween, the cylinder including at least one inlet valve through which combustion gases are fed into the combustion chamber and at least one exhaust valve through which spent combustion gases egress the combustion chamber, the piston moving the cylinder in a cycle between top dead center where the piston is located closest to the head location and bottom dead center where the piston is located furthest from the head location, and including at least one fuel injector located at or in the head location,
and wherein the method comprises:
injecting the ammonia fuel into the combustion chamber of each cylinder as at least one fuel jet with a timing of:
after the at least one exhaust valve of the respective cylinder is substantially closed; and
before the respective piston moves to at most 35 degrees, preferably at most 45 degrees, prior to top dead centre.

41. The method of claim 40, wherein the ammonia fuel is injected into the combustion chamber of each cylinder during compression stroke of the engine cycle.

42. The method of claim 40, wherein the ammonia fuel is injected into the combustion chamber of each cylinder with a timing of at least one of:
(A) after the at least one exhaust valve is substantially closed; and before the piston moves to 35 degrees prior to top dead centre;
(B) after the at least one exhaust valve is substantially closed; and before the piston moves to 45 degrees prior to top dead centre; or
(C) after the at least one exhaust valve is substantially closed; after the at least one inlet valve is closed; and before the piston moves to 35 degrees before top dead centre.

43. The method of claim 40, wherein the ammonia fuel is injected into the combustion chamber of each cylinder such that one of the following occurs:
(A) the fuel jets enter the cylinder having a jet centreline that is at an angle of between −90° and −35° relative to a base line which is perpendicular to the centreline of the respective cylinder;
(B) the fuel jets enter the cylinder having a jet centreline that is at an angle of between −90° and −50°, preferably between −90° and −65° relative to a base line which is perpendicular to the centreline of the respective cylinder;
(C) the fuel jets enter the cylinder having a jet centreline that is at an angle of between −90° and −30° relative to a base line which is perpendicular to the centreline of the respective cylinder;
(D) the fuel jets enter the cylinder having a jet centreline that is at an angle of between −90° and −65° relative to a base line which is perpendicular to the centreline of the respective cylinder, and wherein injection is timed to occur after the at least one exhaust valve closes and before the piston moves to 35 degrees of top dead centre; or
(E) that the fuel jets enter the cylinder having a jet centreline that is at an angle of between −90° and −50° relative to a base line which is perpendicular to the centreline of the respective cylinder, and wherein injection is timed to occur after the at least one exhaust valve closes and before the piston moves to 45 degrees of top dead centre.

44. The method of claim 40, wherein the ammonia fuel is:
at least one of a gaseous ammonia fuel, or a liquid ammonia fuel; or
a blend of liquid ammonia with at least one or water, or another fuel, preferably selected from at least one of: iron picrate solution, hydrazine, or ammonium nitrate.

45. The method of claim 40, wherein the at least one fuel injector is located in a cylinder head at the head location and comprises at least one of:
a single fuel injector located in the center of the cylinder head; or
at least two fuel injectors spaced apart across the diameter of the cylinder head.

46. The method of claim 40, wherein the at least one fuel injector comprises one of:
at least one semi-axial nozzle fuel injector located near the centre of the cylinder with near fuel jets directed downwards; or
at least one semi-axial discharge nozzle liquid ammonia injector(s) located near the cylinder wall with near semi-axial fuel jets directed downwards towards the piston.

47. The method of claim 40, wherein the reciprocating engine comprises at least one of:
a compression ignition engine; or a spark, plasma or laser ignition engine;
a two-stroke engine, or a four-stroke engine; or
crosshead or trunk uniflow engine.

48. The method of claim 40, wherein the head location comprises a cylinder head of the cylinder.

49. The method of claim 40, wherein each cylinder including two pistons that move reciprocally within that cylinder in opposite directions, forming a compression end at the head location and combustion chamber therebetween, at least one inlet valve through which combustion gases are fed into the combustion chamber and at least one exhaust valve through which spent combustion gases egress the combustion chamber, the pistons moving the cylinder in a cycle between top dead center where the piston is located closest to the opposite piston and bottom dead center where the piston is located furthest from the opposite piston, and including at least one fuel injector located in the cylinder wall.

50. A method of injection of liquid or gaseous ammonia fuel into a reciprocating engine that includes at least two cylinders, each cylinder including a piston that moves reciprocally within that cylinder, each cylinder having a head location at one end located opposite to a compression end of the piston and defining a combustion chamber therebetween, the cylinder including at least one inlet valve through which combustion gases are fed into the combustion chamber and at least one exhaust valve through which spent combustion gases egress the combustion chamber, the piston moving the cylinder in a cycle between top dead center where the piston is located closest to the head location and bottom dead center where the piston is located furthest from the head location, and including at least one fuel injector located in the wall of the cylinder spaced away from the head location, the injector being positioned to inject fuel into the combustion chamber, and
wherein the method comprises:
injecting the ammonia fuel into the combustion chamber of each cylinder as at least one fuel jet such that the fuel jets enters the combustion chamber having a jet centreline that is at an angle of between −80° and 80° relative to a base line which is perpendicular to the centreline of the respective cylinder, and
wherein injection is timed to occur:
after the at least one exhaust valve of the respective cylinder is substantially closed; and
before the at least one fuel injector is covered by the respective piston when moving from bottom dead center to top dead center in each respective cylinder.

51. The method of claim 50, wherein the injectors are located in the cylinder sidewall in the lower half of the cylinder relative to movement of the piston between top deal center and bottom dead center.

52. The method of claim 50, wherein the ammonia fuel is injected into the combustion chamber of each cylinder during compression stroke of the engine cycle, and preferably after the at least one inlet valve is closed.

53. The method of claim 50, wherein the at least one fuel jet is injected into combustion chamber having one of:
a jet centreline that is at an angle of −80° and 40° relative to a base line which is perpendicular to the centreline of the respective cylinder;
a jet centreline that is at an angle of −80° and 0° relative to a base line which is perpendicular to the centreline of the respective cylinder; or
a jet centreline that is at an angle of −80° and −40° relative to a base line which is perpendicular to the centreline of the respective cylinder.

54. The method of claim 50, wherein the ammonia fuel is:
at least one of a gaseous ammonia fuel, or a liquid ammonia fuel; or
a blend of liquid ammonia with at least one or water, or another fuel, preferably selected from at least one of: iron picrate solution, hydrazine, or ammonium nitrate.

55. The method of claim 50, wherein the at least one fuel injector comprises at least one of:
a single fuel injector;
at least two fuel injectors circumferentially spaced apart around the circumference of the cylinder wall.
at least one semi-axial nozzle fuel injector located near the centre of the combustion chamber when the piston is bottom dead center with near fuel jets directed downwards; or
at least one liquid ammonia injector placed low in the cylinder wall, preferably closer to the compression end of the piston than the cylinder head when the piston is bottom dead center.

56. The method of claim 50, wherein the reciprocating engine comprises at least one of:
a compression ignition engine; or a spark, plasma or laser ignition engine;
a two-stroke engine, or a four-stroke engine; or
a crosshead or a trunk uniflow engine

57. The method of claim 50, wherein the head location comprises a cylinder head of the cylinder.

58. The method of claim 50, wherein each cylinder including two pistons that move reciprocally within that cylinder in opposite directions, forming a compression end at the head location and combustion chamber therebetween, at least one inlet valve through which combustion gases are fed into the combustion chamber and at least one exhaust valve through which spent combustion gases egress the combustion chamber, the pistons moving the cylinder in a cycle between top dead center where the piston is located closest to the opposite piston and bottom dead center where the piston is located furthest from the opposite piston, and including at least one fuel injector located in the cylinder wall.

59. The method of claim 50, further comprising:
injecting a pilot fuel, preferably diesel, into the combustion chamber subsequent to injection of the ammonia fuel into the combustion chamber of each cylinder.
